(19) United States
(12) Patent Application Publication
(10) Pub. No.: US 2003/0008043 A1
(43) Pub. Date: Jan. 9, 2003

(54) Method for processing mature chickens

(76) Inventors: Bill Crider, Metter, GA (US); Max Harrell, Metter, GA (US); Phil Hudspeth, Metter, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/898,352

(22) Filed: Jul. 3, 2001

(51) Int. Cl. A23L 1/31

(52) U.S. Cl. 426/281

(57) ABSTRACT

A method of processing mature chickens comprises deboning the chicken into individual pieces and exposing the muscle fibers of the individual pieces to the ambient environment. A water binding agent is introduced to the muscle fibers and the muscle fibers are vacuum tumbled for dispersing the water binding agent throughout the muscle fibers in an uniform manner.

This invention relates generally to the processing of chickens and more particularly to the processing of mature chickens in a deboned/cooked manner which enables the chicken to be utilized in food markets which require tender chicken meat.

### BACKGROUND OF THE INVENTION

Chickens are classified into several different groups depending on the age of the chicken and the function of the chicken. Broiler chickens are defined as being between six and eight weeks of age. More mature chickens include breeder hens which are generally sixty-six weeks old and Leghorns which are generally two years old. Leghorns are utilized principally as egg layers to produce eggs for consumption. Breeders also lay eggs, but rather than for consumption, their eggs are hatched into broiler chicks. Mature chickens are defined as chickens which have incurred the calcification of their keel.

Other than for eggs, chickens are typically processed for consumption. The consumption market for chickens is generally broken down into two separate groups. The first group consists of markets which require ready to eat chicken. These markets include chicken utilized as appetizers, shredded strips, sandwich toppings, pizza toppings, chicken nuggets, rolled/loaf, etc. The chicken utilized for the ready to eat market is the broiler chicken as the broiler chicken is younger and tender. The second group of consumption markets include canned meats and ready to cook meats which either may be whole bone in chickens or individual quick frozen chicken parts. This group consists of both broiler chickens and mature chickens.

The primary difference between broiler chickens and the mature chickens is the tenderness of the meat due to the structure and configuration of the respective muscle fibers. The muscle fibers of the broiler chicken are not cross-connected resulting in a tender meat. However, as chickens mature, their muscle fibers become cross-connected and also experience structural and textural change making the meat tougher. Thus, the broiler chicken is preferred by the consuming market and consequently is the predominate portion of the poultry processing industry.

The size of the broiler processing industry dwarfs the mature chicken processing industry. According to the United States Department of Agriculture National Agricultural Statistics Service, in 1999, the value of production for broilers exceeded $15 billion dollars while the value of all other chickens was just over $67 million. The total number of broilers produced in 1999 was 8.15 billion while the total of all other chickens sold in 1999 totaled 204 million. Thus it can be seen that the broiler component of the chicken poultry industry is over 99.6% of the entire chicken poultry market. This extreme demand for broiler chickens is due to their tenderness which is desired by the consumer in ready to eat markets in addition to their acceptable yields by being easily processed which is required by the production industry. Furthermore, due to the desirability of the broiler for the food industry, the price for broilers fluctuate in the high 30 to low 40 cents per pound whereas the price for other chickens fluctuate between 7 and 8 cents per pound due to their limitations of consumptionable use.

The processing of broiler chickens is typically done in an operation which initially involves de-boning the chicken and then cooking the chicken. De-boning involves removing the chicken meat from the bones prior to further processing. This is generally accomplished in a de-boning line wherein the chicken carcass is positioned on a cone and incisions are made for the removal of legs, wings and breast meat. Meat is hand picked off of the carcass and then further processed. In order for high yields to be met, it is the custom in the chicken processing industry to only de-bone broiler chickens. This is due to the fact that the broiler chickens have meat which is easily removed from the carcass in sufficient quantity to produce the required yields for a profitable business. Yield is calculated by measuring the weight of the chicken prior to processing versus the weight after processing.

In the processing of broiler chickens, marinate compositions may be added to increase yield and/or to add flavoring. The marinate may be added either by injection or by tumbling. U.S. Pat. No. 5,431,937 discloses a method of preparing oven-roasted food by injecting a chicken with a special browning reaction-facilitator and smoke flavoring. U.S. Pat. No. 6,040,013 discloses a vacuum tumbling method for meats to infuse chicken meat with a marinade. The membrane which covers the muscle fibers of broiler chickens is permeable. Accordingly, during vacuum tumbling of broilers, marinade is positioned inside the tumbler and the marinade passes through the membrane and enters the muscle fibers.

For mature chickens, the unprocessed meat is tougher and is not denatured. Consequently, the de-boning of mature chickens is difficult and results in less meat being removed from the carcass resulting in lower yields. It is the resultant lower yields which has dissuaded chicken processors from processing pre-cooked, de-boned mature chickens as the process is unprofitable. Accordingly, mature chickens are generally processed in a manner wherein the chickens are first cooked. The cooking component of this process requires sufficient cooking of the chicken wherein the protein in the meat is denatured enabling the meat to be removed from the bone or the chicken is sold whole as a boned-in ready to cook chicken. Traditional cooking methods utilize large kettles wherein the mature chicken is cooked for at least two and a half hours at temperatures over 160° Fahrenheit. This is required to denature the protein. However, due to the long cooking time and high temperature, yields are lessened due to moisture and other fluids being processed out of the chicken. To increase yield, it is known to inject bone-in mature chickens with a yield enhancing solution. Deboning of pre-cooked mature chickens is also somewhat difficult due to the softening of the carcass resulting in bones errantly being present in the deboned meat which raises quality issues. Consequently, cooked/de-boned mature chickens are predominately only used for canned goods and individual quick frozen components. Overall, the long cooking time required to denature the protein of the mature chicken and loss of yield due to the long cooking process makes mature chickens unsuitable for use in ready to eat markets. Additionally the texture of mature chickens is generally unsuitable for ready to eat markets.

Accordingly, a highly profitable business may result if mature chickens could be processed in a manner which enabled them to be suitable for ready to eat markets.

Thus, there is a need for a method of processing mature chickens in a manner which increases yield sufficiently for mature chickens to be utilized in ready to eat markets.

Thus, it is an object of the present invention to provide a method of processing mature chickens which produces increased yields enabling the mature chickens to be utilized in ready to eat markets.

Also, it is an object of the present invention to provide a method of processing mature chickens which enables them to be tenderized without requiring extensive cooking times to denature the protein.

Additionally, there is a need for a method of processing mature chickens which enables them to be tenderized for use in ready to eat markets and at a yield which is profitable.

### SUMMARY OF THE INVENTION

The above objectives are accomplished according to the present invention by providing a method of processing mature chickens which includes first deboning the mature chicken into individual pieces. The muscle fibers of each individual piece is then exposed to the ambient environment. Once the muscle fibers are exposed, a water binding agent is introduced to the muscle fibers. Once the water binding agent is introduced into the muscle fibers, the individual pieces are placed within a tumbler and undergo vacuum tumbling for dispersing the water binding agent uniformly throughout the muscle fibers. This process produces a chicken meat which is sufficiently tender for consumption in ready to eat markets and at a yield which is profitable to the mature chicken processor.

### DESCRIPTION OF THE DRAWINGS

The methods designed to carry out the invention will hereinafter be described, together with other features thereof.

The invention will be more readily understood from a reading of the following specification and by reference to the accompanying drawings forming a part thereof:

FIG. 1 illustrates the prior art method of processing mature chickens;

FIG. 2 illustrates the method of processing mature chickens according to the present invention

FIG. 3a illustrates one method of exposing the muscle fiber of the mature chicken;

FIG. 3b illustrates a second method of exposing the muscle fiber of the mature chicken;

FIG. 4 illustrates the advantages of the invention identifying the markets available for mature chickens processed under the invention.

### DESCRIPTION OF A PREFERRED EMBODIMENT

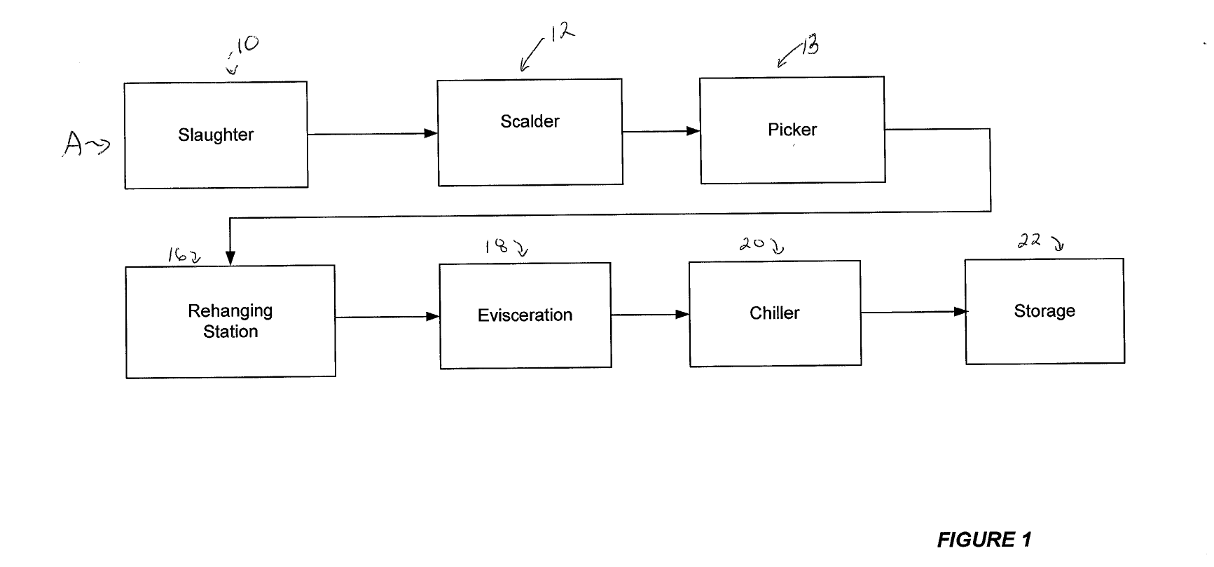

Referring now in more detail to the drawings, the invention will now be described in more detail. The present invention relates to the processing of mature chickens. Mature chickens are known in the industry as those chickens which have had the calcification of their keel occur. FIG. 1 illustrates the standard process of preparing mature chickens. Mature chickens A are initially processed as is typical in the industry. The mature chickens are placed upside down on a hanger. The chickens are slaughtered 10 and sent through a scalder 12 which scalds the chickens with hot water so that the feathers can be easily picked off the carcasses at the picker 13. The processing line then transports the processed carcasses to a conveyor belt onto which they are dropped for rehanging onto a second “clean” processing line at a rehanging station 16. The second processing line also has support or suspension devices from which the chicken carcasses are suspended. The suspended chicken carcasses are then transported through an evisceration process 18 where the carcasses are eviscerated and then inspected by an authorized USDA inspector. The eviscerated and inspected carcasses are then transported by the second processing line to a cold-water chiller 20 where the processed carcasses are chilled prior to storage in a storage area 22.

From this initial processing, the mature bone-in chickens may be sold as ready to cook birds or further processed for canned product or as individual quick frozen components. Ready to cook birds typically yield 65% of the initial mature chicken live weight. In the prior art prior to this invention, if the mature chickens were to be utilized for canned product or as individual quick frozen components, the bone-in mature chicken would be cooked at 160° F. for over two and a half hours. Such cooking is required to denature the protein of the mature chicken to allow for deboning to occur so that the meat could be further processed in cans or as individual quick frozen components. Typically due to the extensive cooking time and temperature necessary to denature the protein of the mature chicken, the yields are less than 35%.

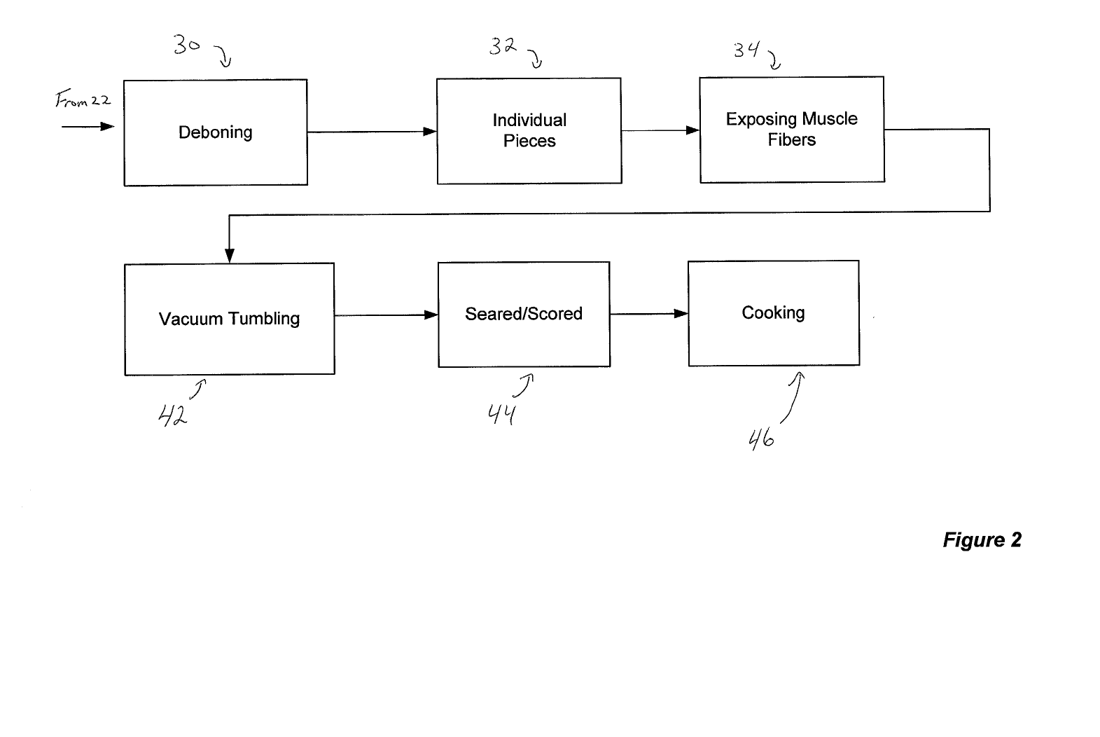

As shown in FIG. 2, an improved process for processing mature chickens according to the present invention further includes removing the chilled chickens to a de-boning station 30. At the de-boning station 30, the mature chickens are placed on a cone and de-boned. The de-boned meat is separated into wings, legs, and other components. The breast meat and other separated meat, hereinafter individual pieces 32, are placed on a conveyor for further processing.

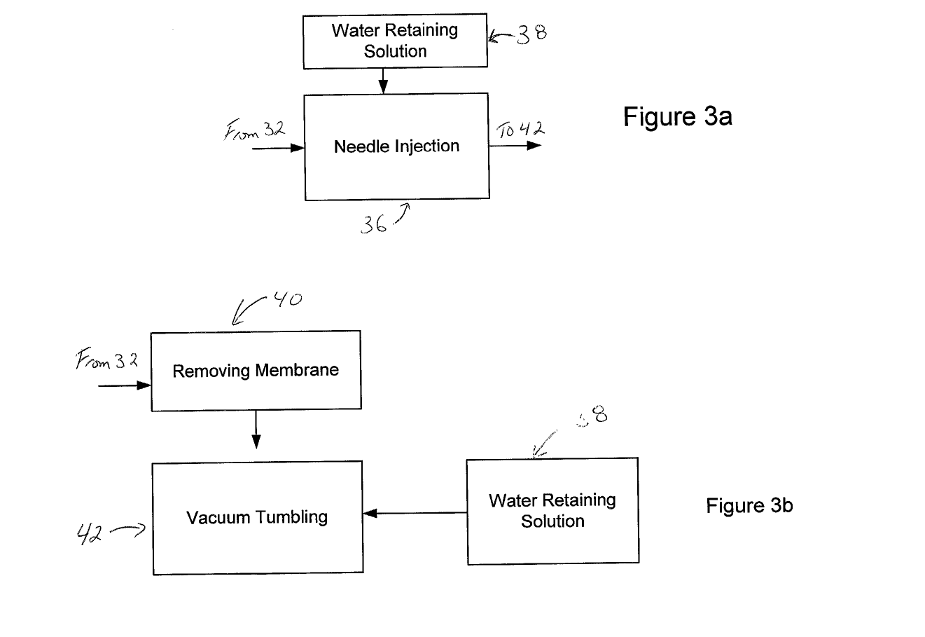

The first subsequent processing procedure involves step 34 exposing the muscle fibers of the individual pieces to the ambient environment. A first method of exposing the muscle fibers is shown in FIG. 3b which entails removing the membrane at step 40 which covers the muscle fibers. A second alternative method is shown in FIG. 3a which entails penetrating the membrane which covers the muscle fibers via the use of needles at step 36. If needles are utilized, the individual pieces 32 are manipulated to be of a level height when entering the injection station.

The injection station consists of an injection box which houses a plurality of injection needles. In the preferred equipment, the injection needles are arranged in banks, so that about a hundred needles traverse the interior of injection box. The processed meat enters the interior of injection box for being injected with a water retaining solution or water binding agent 38. The water retaining solution may consist of starch blends; phosphates; salt; soy protein isolates and/or concentrates; antioxidants; seasoning and other FDA/USDA approved additives. The water retaining solution is injected into the processed meat via the needles. The needles are resiliently mounted and valved so that no water retaining solution issues from the tip of any needle which has not engaged any processed meat and so that each needle penetrates into the processed meat an amount which is limited by resistance to penetration. The processed meat is injected at various percentages depending upon the end product desired. For instance, a product that will be cooked, diced and retorted will be injected with a different level of solution than one that is going to be cooked, diced and frozen or one that will be packed in a flexible pouch will be treated differently than another product that is to be cooked and sold refrigerated. Preferably, the water binding agent is injected in an amount at least equal to fifteen percent of the weight of the individual pieces.

Once the processed meat has been injected with the water retaining solution, the processed meat exits the injection box and is carried to a vacuum tumbler 42. The individual meat pieces 32 are placed within the interior of vacuum tumbler 42 for vacuum tumbling. The application of a vacuum expands and removes the gases located in the interstitial spaces within the processed meat and assists in effecting the absorption of the water retention solution into the meat in a uniform manner. The application of a vacuum also helps mechanically distort the meat by expanding it, which assists in the breakdown of the meat fibers to enhance tenderization. The vacuum tumbling is undertaken at a range of at least twenty-five inches of mercury to twenty-eight inches of mercury for a time period of at least twenty minutes and in some cases thirty minutes depending on the amount of water binding solution added. Without the permeation of the membrane which would ordinarily cover the muscle fibers of the mature chicken, vacuum tumbling would be ineffective as the membrane is impervious to fluid penetration and the water binding agent would not pass into the muscle fibers. Accordingly, the exposure of the muscle fiber to the ambient environment is critical to the invention for enabling the water binding agent to be presented directly to the muscle fibers.

In the process where the membrane is removed at step 40 exposing the muscle fibers to the ambient environment, the water retaining solution 38 is placed in the interior of vacuum tumbler 42. During the vacuum tumbling process, the vacuum forces the water binding agent to engage the muscle fibers and be absorbed by the muscle fibers. In this process, the vacuum tumbling process is preferably undertaken at a level of twenty-five to twenty-eight inches of mercury for a time period of at least forty minutes to allow for the uniform distribution of the water retaining solution throughout the muscle fibers.

The uniform allocation of the water retaining solution in the muscle fibers results in a tender muscle fiber throughout the entire fibers. Additionally, the water retaining solution results in increased yields.

After the processed meat is vacuum tumbled, the processed meat is removed from the tumbler and may be subsequently processed in several different processes. For instance, the processed meat may be transferred to a lay-down belt and conveyed through a cooking system. Prior to cooking, the processed meat may be seared or scored at step 44. Since the individual pieces are deboned, cooking at step 46 is less than an hour and depending on the amount of water retaining or binding solution added maybe thirteen, fourteen and a half or thirty minutes and is undertaken at a temperature of approximately one hundred and ninety degrees Fahrenheit. This cooking time is significantly less than the typical two hours required for bone in chicken and enables the yield to be maintained at a high level. This process has resulted in yields ranging from ninety-six to ninety-nine percent from the start of the cooking process. Prior to this invention, such yields were unattainable for de-boned cook mature chickens limiting mature chickens to be processed with the bone-in at cooking and either de-boned thereafter or sold whole. Consequently, the cooked mature processed meat can then subsequently be diced; sliced; or sized in portions for use in retorting or flexible pouch packing.

Additionally, instead of being processed via a continuous cooking system, the processed meat may be blended raw and formed into other products such as nuggets; patties and other portion controlled formed products. Alternatively, the product may be further seasoned; portioned, or glazed to be used in entrees.

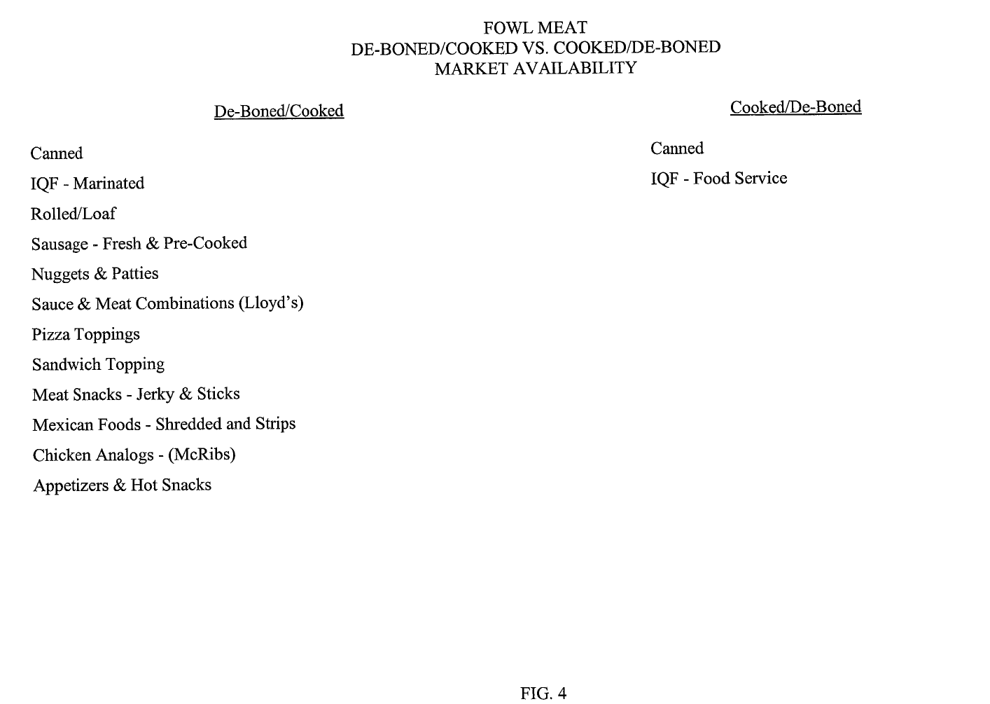

FIG. 4 illustrates the advantages of the invention. Column 1 illustrates the multiple markets available for mature chickens processed under the present invention. The processed meat processed under the present invention exhibits a tenderness required by consumers at a yield required for profitability by the industry. The ready-to-eat markets are those markets currently only available for broilers while the markets in column 2 are the primary markets available for mature chickens which are processed via the traditional process. As discussed in the background, the difference in markets results in meat utilized in markets identified in Column 1 for at least thirty cents per pound while mature chickens utilized in markets identified in Column 2 only reach seven cents per pound.

Thus it may be seen that a successful method may be utilized for processing mature chickens which enable the mature chicken to be sold in consumer markets heretofore unavailable to mature chicken processors. By deboning the mature chicken, less cooking time is required. Additionally, by exposing the muscle fibers of the mature chicken to the ambient environment, water retaining solution may be directly introduced to the muscle fibers and via vacuum tumbling disperse throughout the entire muscle fibers in a uniform manner resulting in a tender chicken.

I claim:

1. A method of processing a mature chicken:
deboning said chicken into individual pieces;
exposing the muscle fibers of the individual pieces to the ambient environment;
introducing a water binding agent to said muscle fibers;
vacuum tumbling said individual pieces for dispersing said water binding agent throughout said muscle fibers in a uniform manner.

2. The method of claim 1 wherein the membrane surrounding said muscle fibers is punctured for exposing said muscle fibers.

3. The method of claim 2 wherein said water binding agent is injected into said muscle fibers.

4. The method of claim 3 wherein said water binding agent consists of starches.

5. The method of claim 3 wherein said water binding agent is injected in an amount at least equal to fifteen percent of the weight of the individual pieces.

6. The method of claim 3 wherein said vacuum tumbling occurs at least at twenty-five inches of mercury for a time period of at least twenty minutes.

7. The method of claim 1 wherein the membrane surrounding said muscle fibers is removed for exposing said muscle fibers.

8. The method of claim 7 wherein said water binding agent is positioned within a tumbler for vacuum tumbling.

9. The method of claim 8 wherein said vacuum tumbling is undertaken at least at twenty-five inches of mercury and for at least forty minutes.

10. The method of claim 9 wherein said water binding agent is at an amount at least equal to fifteen percent of the weight of the individual pieces.

11. A method of processing a mature chicken:
deboning said chicken into individual pieces;
penetrating a membrane covering muscle fibers of said individual pieces via needles;
injecting a water binding agent into said individual pieces via said needles;
thereafter vacuum tumbling said individual pieces enabling said water binding agent to uniformly disperse within said muscle fibers of said individual pieces.

12. The method of claim 11 further including the step of cooking said individual pieces after said tumbling at a time less than one hour.

13. The method of claim 11 wherein said vacuum tumbling is conducted at lest at twenty-five inches of mercury at a time of at least twenty minutes.
